(19) United States
(12) Patent Application Publication
(10) Pub. No.: US 2005/0088454 A1
(43) Pub. Date: Apr. 28, 2005

(54) Method of displaying an image of a windowless object

(76) Inventor: Kuo-Ching Lin, Dali City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/963,074

(22) Filed: Oct. 12, 2004

(30) Foreign Application Priority Data
Oct. 22, 2003 (TW) 92129352

(51) Int. Cl. H04B 1/66

(52) U.S. Cl. 345/589

(57) ABSTRACT

A method of displaying an image of a window object, includes the steps of: (a) checking a display mode of a display module, and allocating a first section and a second section in a buffer if the resolution of the display mode is below a predetermined level; (b) outputting an original color value of a front image to the first section and the second section respectively, and producing a first view in the first section and a second view in the second section accordingly; (c) calculating an alpha value of the front image by means of the first view and the second view, and saving the alpha value to the first section; and (d) outputting the original color value and the alpha value to display an image of a windowless object.

This application claims the benefit of Taiwan application Serial No. 92129352, filed Oct. 22, 2003, the subject matter of which is incorporated herein by reference.

### BACKGROUND OF THE INVENTION

1. Field of the Invention

The invention relates in general to a method of displaying an image, and more particularly to a method of displaying an image of a windowless object.

2. Description of the Related Art

ActiveX, an open type of standards capable of connecting various platforms and environments, is developed and created by the Microsoft Inc. The ActiveX technology, an augmentation and update of an object linking and embedding technology, has the features of crossing platforms, language irrelevance, and document and component orientation. The structure of ActiveX is based on the component object model (COM) and provides plural ActiveX control components, which may be called directly. The ActiveX control components may be applied in any container, which supports COM standards or is embedded into a network page as an Internet control. For example, a flash object is exactly an ActiveX control component having interactive and animation functions. As an object complying with ActiveX standards, the flash object may communicate with a container by means of an interface already defined according to ActiveX standards.

Generally speaking, a windowless control setting complying with ActiveX standards enables an object to be presented in the form of an irregular window. However, when a display card is under 16-bit display mode, the flash object will not output an alpha value, which represents the transparency of an image. Even though the flash object has been set at a windowless mode, the flash object still cannot be presented in the form of an irregular window due to the lack of an alpha value.

### SUMMARY OF THE INVENTION

It is therefore an object of the invention to provide a method of displaying the image of a windowless object. Regardless of the display mode, the presented image of an object may have an irregular and transparent outlook so as to generate a user's dynamic windowless interface.

It is another object of the invention to provide a method of displaying an image of a window object, wherein the method includes the steps of: (a) checking a display mode of a display module, and allocating a first section and a second section in a buffer if the resolution of the display mode is below a predetermined level; (b) outputting an original color value of a front image to the first section and the second section respectively, and producing a first view in the first section and a second view in the second section accordingly; (c) calculating an alpha value of the front image by means of the first view and the second view, and saving the alpha value to the first section; and (d) outputting the original color value and the alpha value to display the image of the windowless object.

According to the object of the invention, another method of displaying a windowless front image is disclosed, wherein the front image includes pixels 1˜n, the method includes the steps of: (a) blending a pixel 1 with a first color to generate a pixel 1′; (b) blending the pixel 1 with a second color to generate a pixel 1″; (c) calculating a first alpha value, which corresponds to the pixel 1, according to the pixel 1′ and the pixel 1″; (d) repeating step (a) to step (c) to obtain a second alpha value to an n-th alpha value, which respectively correspond to pixels 2˜n; and (e) generating a windowless front image according to these pixels 1˜n and the first alpha value to the n-th alpha value.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a diagram of a generating device of a user's dynamic windowless interface according to a preferred embodiment of the invention; and

FIG. 2 is a flowchart of a method of displaying an image of a windowless object according to a preferred embodiment of the invention.

### DETAILED DESCRIPTION OF THE INVENTION

The method of generating a user's dynamic windowless interface according to the invention is able to be recorded in a computer readable recording medium. The computer system provides a generating device of a user's dynamic windowless interface after reading the recording medium and executing the method of generating a user's dynamic windowless interface.

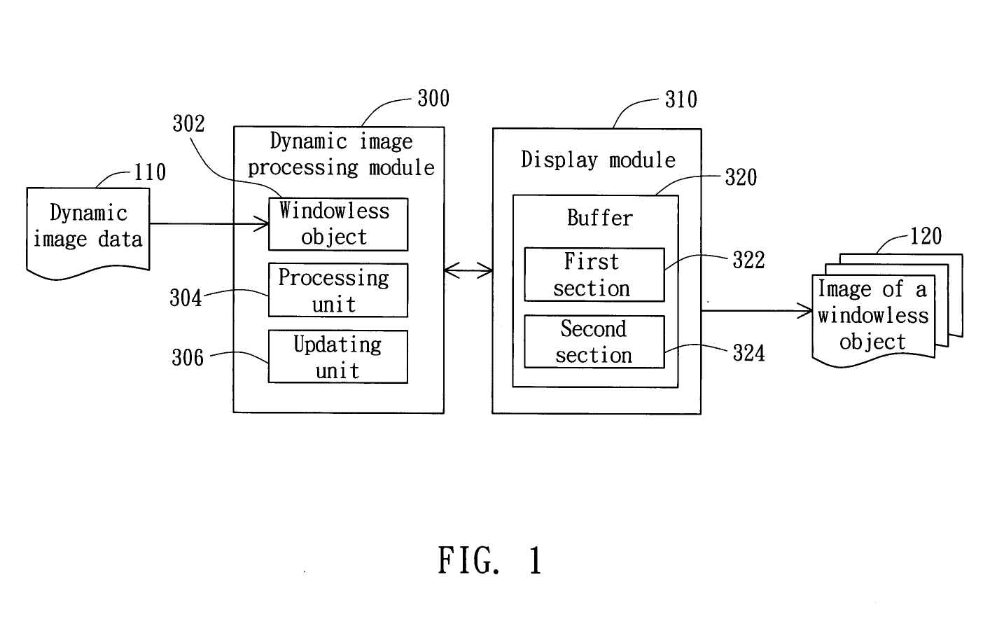

Referring to FIG. 1, a diagram of a generating device of a user's dynamic windowless interface according to a preferred embodiment of the invention is shown. The generating device of the user's dynamic windowless interface mainly includes a dynamic image processing module 300 and a display module 310. The display module 310 has a buffer 320 and various settings of display modes such as the 16-bit high color setting, the 24-bit true color setting and the 32-bit true color setting. The dynamic image processing module 300 includes a windowless object 302, a processing unit 304 and an updating unit 306. For example, the dynamic image processing module 300 may be a container complying with ActiveX standards. As an ActiveX control component complying with ActiveX standards, the flash object may be added to the dynamic image processing module 300 as a windowless object 302.

In FIG. 1, the windowless object 302 is loaded onto a dynamic image data 110, i.e., the flash object is loaded onto flash files to be played. By means of a windowless control setting of ActiveX standards, the flash object uses a defined interface to communicate with a container.

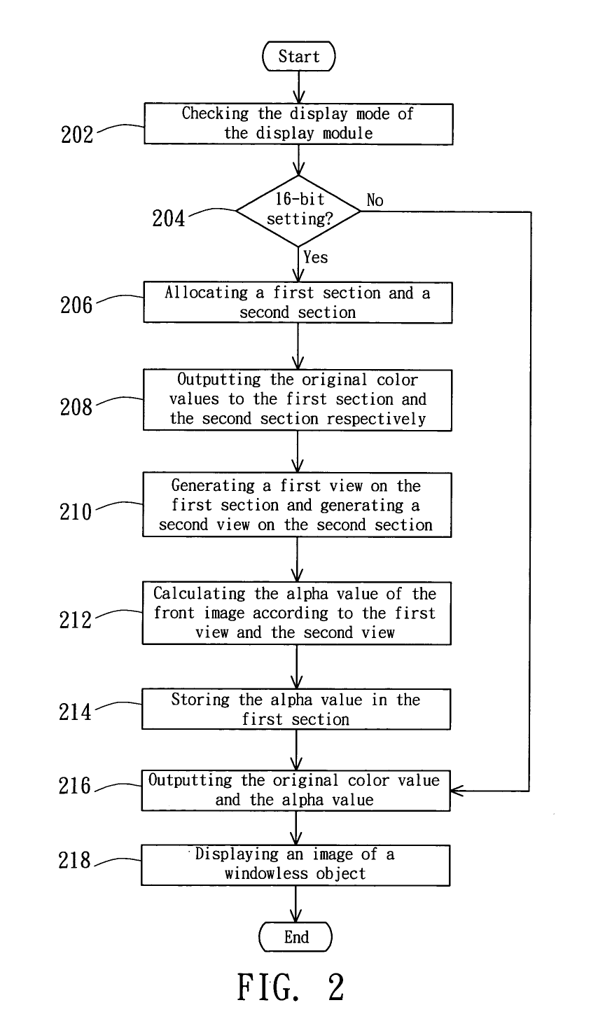

Referring to FIG. 2, a flowchart of a method of displaying an image of a windowless object according to a preferred embodiment of the invention is shown. The method of displaying an image of a windowless object begins with step 202: checking the display mode of the display module 310. Next, in step 204, if the display mode is determined not to be 16-bit setting by means of a container, step 216 is directly performed to output the original color value and the alpha value of the image. It is noted that when the display module 310 is of 24-bit setting or 32-bit setting, the image outputted by the flash object has already included the value of the alpha channel for describing pixel transparency. So, when the alpha value of the window part of the image is 0, a transparent window is displayed in step 218, such that the image of a windowless object is displayed on the full frame.

If the display mode is determined to be 16 bits by means of a container in step 204, step 206 is performed since the flash object fails to output the value of the alpha channel under 16-bit display mode. The following steps 206˜212 disclose the method by which the processing unit 304 of the dynamic image processing module 300 obtains the alpha value of image pixel.

In step 206, a first section 322 and a second section 324 of equal size are allocated on the buffer 320, as shown in FIG. 1. The background color for the first section 322 and the background color for the second section 324 are preferably to be marked the black color and the white color respectively. Next, in step 208, the container has the flash object to output the original color value of the front image to the first section 322 and the second section 324 by means of an IVewObject::Draw interface function of ActiveX standards. Meanwhile, in step 210, the first section 322 generates a first view while the second section 324 generates a second view. Next, step 212 is performed to calculate the alpha value of the front image according to the first view and the second view. The image of a windowless object includes pixels 1˜n whose pixel values are functions of the original color value and the alpha value. The method of displaying the image of a windowless object includes the steps of: (a) blending a pixel 1 with a first color to generate a pixel 1′; (b) blending the pixel 1 with a second color to generate a pixel 1″; (c) calculating a first alpha value, which corresponds to the pixel 1, according to the pixel 1′ and the pixel 1″; (d) repeating step (a) to step (c) to obtain alpha values 2˜n, which respectively correspond to pixels 2˜n; (e) generating a windowless front image according to these pixels 1˜n and these alpha values 1˜n.

In order to elaborate the operation of the alpha value of the front image, an example is disclosed below. It is supposed that the R-value of the original color value of a pixel p of the front image is R0, the R-value of the black background of the first section 322 is Rb (Rb=0), the R-value of the white background of the second section 324 is Rw (Rw=255), and a blending function provided by the ActiveX standards is used for the operation of the alpha value (a) of the pixel p. Firstly, the R-value (Rf1) of a first color value of a pixel 1 of the first view is obtained, where the position of the pixel 1 corresponds to the pixel p. The R-value (Rf1) of the first color value is a function of the R-value (R0) and the alpha value (a) of the original color value of the front image, and further satisfies equation E1:

$$\begin{matrix}Rf1 = R0 * α / 255 + Rb * ( 1 - α / 255 ) \\ = R0 * α / 255.\end{matrix}$$

Second, the R-value (Rf2) of a second color value of a pixel 2 of the second view is obtained, where the position of the pixel 1 corresponds to the pixel p. The R-value (Rf2) of second color value is a function of the R-value (R0) and the alpha value (α) of the original color value of the front image, and further satisfies equation E2:

$$\begin{matrix}Rf2 = R0 * α / 255 + Rw * ( 1 - α / 255 ) \\ = R0 * α / 255 + 255 * ( 1 - α / 255 )\end{matrix}$$

It can be seen from the above equations E1 and E2 that the alpha value (α), which ranges from 0˜255, is a function of the R-value (Rf1) of the first color value and the R-value (Rf2) of the second color value. When the α-value equals 0, the corresponding pixel is completely transparent; when the α-value equals 255, the corresponding pixel is not transparent at all. Hence the above alpha value may be deducted from the above equations despite that the flash object does not output the alpha value.

In step 214, the calculated alpha value (α) of the front image is stored in the first section 322. Then, the first section 322 includes the original color value and the alpha value of the front image, so that the original color value and the alpha value may be outputted in step 216 and the container may use an application program Win32API UpdateLayeredWindow to update the frame displayed on the display monitor and display the image of a windowless object in step 218. In FIG. 1, the dynamic image processing module 300 uses an updating unit 306 to update the display frame of the windowless object 302, generating a windowless object image 120 on the display frame. The method of displaying an image of a windowless object is terminated here.

As shown in FIG. 1, the windowless object 302 may select the next front image from a dynamic image data 110 loaded and repeat steps 208˜218 of the method of displaying an image of a windowless object to display plural windowless object images 120 for generating the user's dynamic windowless interface so as to provide the flash object with a display of a dynamic object image of an irregular and transparent outlook.

The method of displaying the image of a windowless object disclosed above obtains the alpha value, which cannot be displayed under low resolution or other particular display modes, by means of the allocation of the sections on the buffer and the effect on the color value of the front image by the background colors of the sections. Thus, the windowless object presents an irregular and transparent outlook regardless of what the display mode is and accordingly generates a user's dynamic windowless interface.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A method of displaying an image of a windowless object, wherein the image of the windowless object includes a pixel 1 to a pixel n, and the method comprises the steps of:
(a) blending the pixel 1 with a first color to generate a pixel 1′;
(b) blending the pixel 1 with a second color to generate a pixel 1″;
(c) calculating a first alpha value, which corresponds to the pixel 1, according to the pixel 1′ and the pixel 1″;
(d) repeating the step (a) to the step (c) to obtain a second alpha value to an n-th alpha value, which respectively correspond to the pixel 2 to the pixel n; and
(e) generating the image of the windowless object according to the pixel 1 to the pixel n and the first alpha value to the n-th alpha value.

2. The display method according to claim 1, wherein the first color is black while the second color is white.

3. The display method according to claim 1, wherein the step (a) of blending the pixel 1 with the first color is to dispose the pixel 1 in a first memory section whose background is of the first color for forming the pixel 1′ in the first memory section.

4. The display method according to claim 1, wherein the step (b) of blending the pixel 1 with the second color is to dispose the pixel 1 in a second memory section whose background is of the second color for forming the pixel 2′ in the second memory section.

5. The display method according to claim 1, wherein the step (c) obtains the first alpha value by means of the equation listed below:
α=(Rf1−Rf2)+255
where
α is the first alpha value;
Rf1 is an original first color value of an original color of the pixel 1′;
Rf2 is an original second color value of the original color of the pixel 1″; and
255 is a transparency constant.

6. The display method according to claim 5, wherein the original color is red.

7. The display method according to claim 1, wherein, before step (a), the method further comprises:
adding a windowless object to an image processing module; and
notifying the image processing module that the windowless object is going to update a display frame.

8. The display method according to claim 7, wherein the windowless object is a flash object.

9. The display method according to claim 1, wherein step (e) further comprises:
(e1) writing the first alpha value to the n-th alpha value to the first memory section; and
(e2) outputting the content of the first memory section to an updating unit to generate the image of the windowless object.

10. A computer readable recording medium, for recording a method of displaying an image of a windowless object, wherein the image of the windowless object includes a pixel 1 to a pixel n, and the method comprises the steps of:
(a) blending the pixel 1 with a first color to generate a pixel 1′;
(b) blending the pixel 1 with a second color to generate a pixel 1″;
(c) calculating a first alpha value, which corresponds to the pixel 1, according to the pixel 1′ and the pixel 1″;
(d) repeating step (a) to step (c) to obtain a second alpha value to an n-th alpha value, which respectively correspond to a pixel 2 to a pixel n; and
(e) generating the image of the windowless object according to the pixel 1 to the pixel n and the first alpha value to the n-th alpha value.

11. The display method according to claim 10, wherein the first color is black while the second color is white.

12. The display method according to claim 10, wherein the step (a) of blending the pixel 1 with the first color is to dispose the pixel 1 in a first memory section whose background is of the first color for forming the pixel 1′ in the first memory section.

13. The display method according to claim 12, wherein the step (b) of blending the pixel 1 with the second color is to dispose the pixel 1 in a second memory section whose background is of the second color for forming the pixel 2′ in the second memory section.

14. The display method according to claim 10, wherein the step (c) obtains the first alpha value by means of the equation listed below:
α=(Rf1−Rf2)+255
where
α is the first alpha value;
Rf1 is an original first color value of an original color of the pixel 1′;
Rf2 is an original second color value of the original color of the pixel 1″;
255 is a transparency constant.

15. The display method according to claim 14, wherein the original color is red.

16. The display method according to claim 10, wherein, before step (a) begins, the method further comprises:
adding a windowless object to an image processing module; and
notifying the image processing module that the windowless object is going to update a display frame.

17. The display method according to claim 16, wherein the windowless object is a flash object.

18. The display method according to claim 10, wherein step (e) further comprises:
(e1) writing the first alpha value to the n-th alpha value to the first memory section; and
(e2) outputting the content of the first memory section to an updating unit to generate the image of the windowless object.

19. The recording medium according to claim 1, wherein, after the step (e), the recording medium further comprises:
repeating steps (a), (b), (c), (d) and (e) to generate a user's dynamic windowless interface.
